(19) United States
(12) Patent Application Publication
(10) Pub. No.: US 2016/0336597 A1
(43) Pub. Date: Nov. 17, 2016

(54) High-Energy Cathodes for Lithium Rechargeable Batteries

(71) Applicant: BROOKHAVEN SCIENCE ASSOCIATES, LLC, Upton, NY (US)

(72) Inventors: Feng Wang, Mount Sinai, NY (US); Sungwook Kim, Incheon (KR); Jason Graetz, Calabasas, CA (US)

(21) Appl. No.: 15/111,289

(22) PCT Filed: Jan. 16, 2015
(86) PCT No.: PCT/US2015/011750

§ 371 Date: Jul. 13, 2016

Related U.S. Application Data
(60) Provisional application No. 61/928,789, filed on Jan. 17, 2014.

(51) Int. Cl. H01M 4/58; H01M 4/136; H01M 10/0525

(52) U.S. Cl. CPC H01M 4/582; H01M 10/0525; H01M 4/136; H01M 2004/028

(57) ABSTRACT

Embodiments of the disclosure relate to cathode active materials for lithium-ion batteries. The cathode active material may include particles of at least one ternary metal compound. The ternary metal has a formula M¹_{y}M²₁_{_}_{y}Aₓ where M¹ and M² are different and may be Co, Cu, Fe, Mn, and/or Ni. A may be CI, F, N, O, or S, y may be any number between about 0.05 and about 0.95, and x may be any number between about 0.5 and about 4.

### CROSS-REFERENCE TO A RELATED APPLICATION

This application claims the benefit under 35 U.S.C. 119(e) of U.S. Provisional Application No. 61/928,789 filed on Jan. 17, 2014, the disclosure of which is incorporated herein in its entirety.

### STATEMENT OF GOVERNMENT RIGHTS

This invention was made with Government support under contract numbers DE-AC02-98CH10886 and DE-SC0012704 awarded by the U.S. Department of Energy. The Government has certain rights in the invention.

### BACKGROUND

I. Field of Invention

This disclosure relates generally to compounds which may be used as electrodes. In particular, it relates compounds for use in lithium-ion battery electrodes.

II. Background

Lithium-ion batteries are widely used as energy storage devices for portable electronics, and may be candidates for use in grid-scale storage and hybrid or electric vehicles. In commercially available rechargeable lithium-ion batteries, graphic carbon is commonly used as an anode. Graphic carbon provides a capacity of about 370 mAh/g. However, commonly used cathode compounds, such as LiCoO₂ and LiFePO₄, can only provide a capacity of about 150-170 mAh/g, which is far from matching the capacity of the carbon anode. Thus, for a large-scale application of rechargeable lithium-ion batteries there may be a need for a two-fold improvement in energy and power densities, preferably while also keeping costs low. Metal fluoride (MFx)-based conversion compounds could have been suggested as they may accommodate more than one lithium per transition metal, leading to 2-4 times higher specific capacities than the currently common commercial cathodes (i.e. LiCoO₂, LiFePO₄). Among various MFₓ compounds under consideration, FeF₂ and FeF₃ are leading candidates due to their high cycling reversibility. However, these compounds have low working potential (˜2.5 V), which may limit their applicability. Furthermore, CuF₂ has been used as a high-voltage cathode in primary batteries, but may not be suitable in rechargeable batteries because of a low achievable capacity and poor reversibility.

Therefore, there is a need for low cost cathode compounds for lithium-ion batteries with improved energy and power densities.

### SUMMARY

This disclosure provides embodiments of low cost cathode active materials having improved power densities suitable for lithium-ion batteries. In an embodiment, a cathode active material for a lithium-ion secondary battery is provided. The cathode active material includes particles of at least one ternary metal compound. The ternary metal has a formula

M¹_{y}M²_{1-y}Aₓ

where M¹ and M² are different and are selected from the group consisting of Co, Cu, Fe, Mn, and Ni, A is selected from the group consisting of Cl, F, N, O, and S, y is any number between about 0.05 and about 0.95, and x is any number between about 0.5 and about 4.

In certain embodiments, the cathode active material has an initial discharge capacity of at least 500 or 575 mAh g⁻¹ with a cut-off voltage of 1.5 V or higher at lower voltages.

In certain embodiments, the cathode active material has a charge capacity of at least about 80% or 90% of the initial discharge capacity.

In certain embodiments, the cathode active material has a Li/Li⁺ working potential of at least 2.5 or 3 V.

In certain embodiments, the cathode active material has a capacity above 350 or 400 mAh g⁻¹ at a current of 100 mA g⁻¹ with a cut-off voltage of 1.5 V.

In certain embodiments, the cathode active material has a voltage difference between charge and discharge of less than 0.5 V.

In certain embodiments, the particles of the at least one ternary metal compound is in a single phase in a solid solution.

In certain embodiments, M¹ and M² occupy the same lattice.

In certain embodiments, the particles display a rutile like structure or a monoclinic like structure.

Embodiments also include a cathode for a lithium-ion secondary battery. The cathode includes the cathode active material for a lithium ion secondary battery as defined above, an electrically conductive material, and a binder.

Embodiments also include a lithium-ion secondary battery which includes the cathode as defined above, an anode, and an electrolyte.

Embodiments further include a method of forming a cathode active material. The method includes: forming a mixture of M¹F₂ compound and a M²F₂ compound, wherein M¹ and M² are different and are selected from the group consisting of Co, Cu, Fe, Mn, and Ni; and ball-milling the mixture at between about 50 rpm and about 1000 rpm for between about 1 hour and about 25 hours.

### BRIEF DESCRIPTION OF THE DRAWINGS

FIG. 1A displays synchrotron XRD patterns of Cu_{y}Fe_{1-y}F₂ systems with comparison to standard diffraction patterns of CuF₂ and FeF₂;

FIG. 1B is a schematic illustration of the crystal structures of CuF₂ and FeF₂;

FIG. 1C is a high-resolution TEM image of Cu_{0.5}Fe_{0.5}F₂ nanocrystallites (inset: electron diffraction pattern);

FIG. 1D is an energy diagram of Cu_{y}Fe_{1-y}F₂ phases at various possible configurations as predicted by DFT calculations;

FIG. 1E display electron diffraction patterns of ball-milled Cu_{0.5}Fe_{0.5}F₂ (left), FeF₂ (right, upper), and CuF₂ (right, lower);

FIG. 1F displays XRD patterns of a few different solid solution phases, M¹_{0.5}M²_{0.5}F₂ (M¹, M²=M Cu, Fe, Ni, Co);

FIG. 1G displays lattice parameters of Cu_{y}Fe_{1-y}F₂;

FIG. 2A displays first discharge profiles of Cu_{y}Fe_{1-y}F₂ with Cu/Fe ratios;

FIG. 2B displays charge-discharge profiles of Cu_{0.5}Fe_{0.5}F₂ for the eight cycles (1-4.5 V) (inset: relative capacity as a function of the number of cycles).

FIG. 2C displays CV curves for the 1^{st} and 2^{nd} cycles, in a comparison to that of FeF₃ (dashed curve) at a rate of about C/40.

FIG. 3 displays a typical voltage profile of Cu_{0.5}Fe_{0.5}F₂ for the 1^{st} cycle, in which labels (#1-#11) indicate the (de)lithiated states of electrodes used for the XAS measurements;

FIG. 4A displays GITT profiles of CuF₂, Cu_{0.5}Fe_{0.5}F₂ and FeF₂ at identical relaxation time (5 hours) at a current rate of 5 mA g⁻¹ (inset: magnified profiles at two conversion processes);

FIG. 4B displays GITT profiles of CuF₂, Cu_{0.5}Fe_{0.5}F₂ and FeF₂ after full relaxation (5 hours relaxation for CuF₂, 50 hours relaxation for Cu_{0.5}Fe_{0.5}F₂ and FeF₂);

FIG. 4C displays reaction kinetics of Cu_{0.1}Fe_{0.9}F₂ (at a cut-off voltage of 1.5 V) compared to pure FeF₂ (at a cut-off voltage of 1.5 V for low rate and 1.2 V for high rate), by using current rates of 5, 50, and 100 mA g⁻¹; and

FIG. 5 is a schematic illustration of the phase evolution and reaction pathway in Cu_{y}Fe_{1-y}F₂.

### DETAILED DESCRIPTION

This disclosure provides embodiments of low cost cathode active materials having improved power densities suitable for lithium-ion batteries. The cathode active material may be particles of at least one ternary metal compound. The ternary metal may have a formula

M¹_{y}M²_{1-y}Aₓ (I)

M¹ and M² are different metals, and may be any transition metal. For example, M¹ and M² may be selected from Co, Cu, Fe, Mn, and Ni.

A may be Cl, F, N, O, or S.

y is any number between about 0.05 and about 0.95. All individual values and subranges between about 0.05 and about 0.95 are included herein and disclosed herein; for example, y may be from a lower limit of about 0.05, 0.1, 0.15, 0.2, 0.3, 0.4, 0.5, 0.6, 0.7, 0.75, 0.8, or 0.9 to an upper limit of about 0.1, 0.15, 0.2, 0.3, 0.4, 0.5, 0.6, 0.7, 0.75, 0.8, 0.9, or 0.95. In certain embodiments, y is about 0.33, 0.67, or 0.5.

x is any number between about 0.5 and about 4. All individual values and subranges between about 0.5 and about 4 are included herein and disclosed herein; for example, x may be from a lower limit of about 0.5, 0.75, 1, 1.25, 1.5, 1.75, 2, 2.25, 2.5, 2.75, 3, 3.25, 3.5, or 3.75 to an upper limit of about 0.75, 1, 1.25, 1.5, 1.75, 2, 2.25, 2.5, 2.75, 3, 3.25, 3.5, 3.75, or 4. In certain embodiments, x is about 2.

The ternary metal compound may be made by any method known in the art. For example, the ternary metal compound may be made by combining two metal salts, metal nitrides, metal oxides, metal sulfides, or metal fluorides and subjecting the mixture to a mechanochemical reaction sufficient to form a solid solution phase. For example, the mechanochemical reaction may take place in a ball mill. The compounds may be ball milled at between about 50 rpm and about 1000 rpm. All individual values and subranges between about 50 and about 100 rpm are included herein and disclosed herein; for example, the compounds may be ball milled at an rpm from a lower limit of about 50, 100, 150, 200, 250, 300, 350, 400, 500, 600, 700, 800, or 900, to an upper limit of about 100, 150, 200, 250, 300, 350, 400, 500, 600, 700, 800, 900, or 1000. In one embodiment the compounds are ball milled at 300 rpm.

The compounds may be ball milled for between about 1 hour and about 24 hours. All individual values and subranges between about 1 hour and about 24 hours are included herein and disclosed herein; for example, the compounds may be ball milled from a lower limit of about 1, 2, 3, 4, 5, 6, 7, 8, 9, 10, 12, 13, 14, 15, 16, 17, 18, 19, 20 or 21 hours, to an upper limit of about 2, 3, 4, 5, 6, 7, 8, 9, 10, 12, 13, 14, 15, 16, 17, 18, 19, 20, 21, 22, 23, or 24 hours. In one embodiment the compounds are ball milled for 12 hours.

Alternatively, metals in powder form may be dissolved in fluorosilicic acid in water solution (for example a 20-25 wt % solution) as partially described in Journal of The Electrochemical Society, 156 (6) A407-A416 (2009). The mixture may be heated at 40-45° C. for several hours to allow the reaction of the metals with the fluorosilicic acid. After filtering any potential excess metal, the resulting solution may be dried under heat until forming a dry powder. The resulting powder may then be heat-treated at temperatures ranging from 150 to 300° C. in argon to form pure M¹_{y}M²_{1-y}F₂.

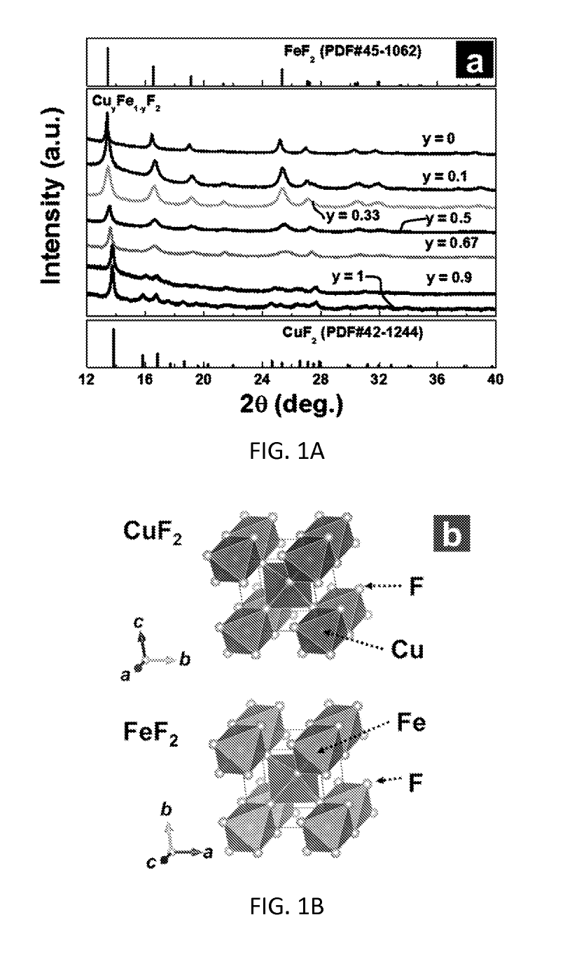

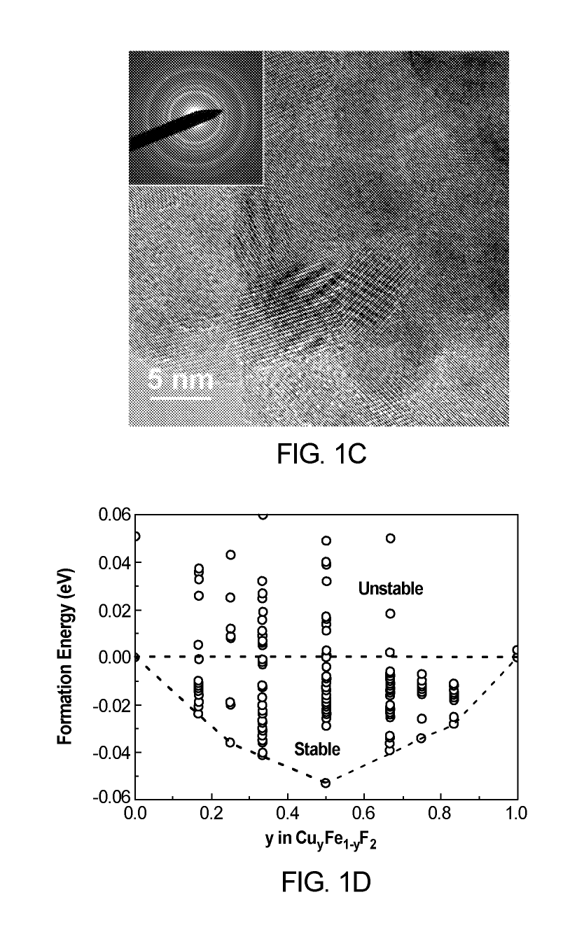

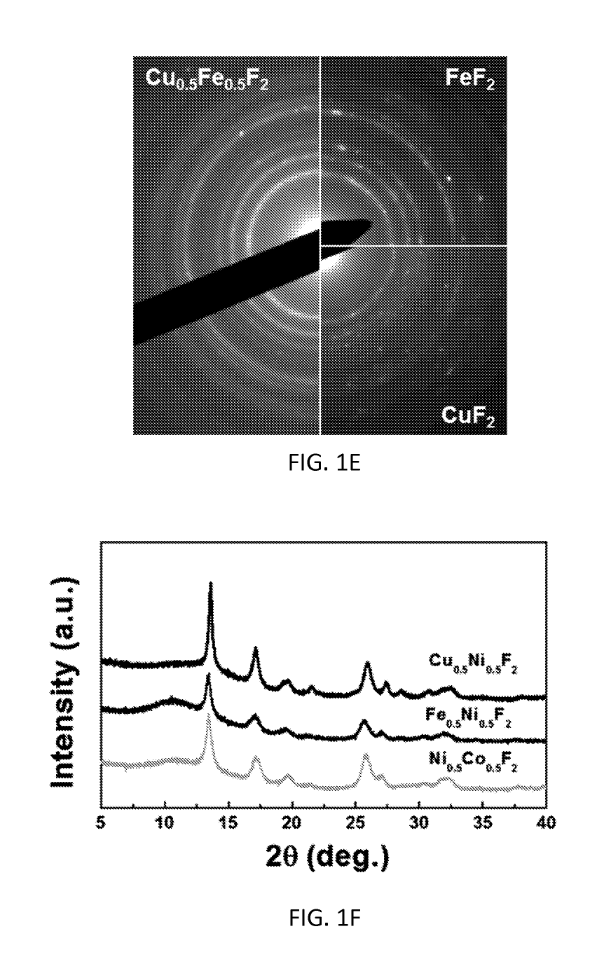

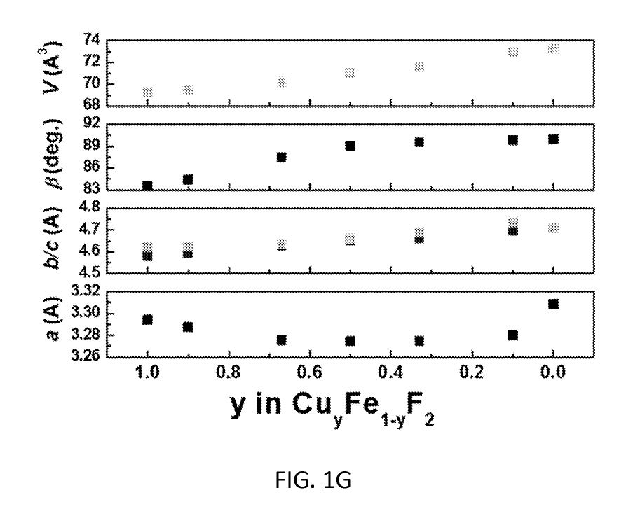

The resulting cathode active materials may consist of a single-phase solid solution (instead of a mixture of two phases) over the whole compositional range. This may be due to the structural similarity between metal mixtures chosen (see for example FIG. 1b). For example, the crystal structure of FeF₂ is tetragonal rutile (space group: P4₂/mnm) and is comprised of FeF₆ octahedra. CuF₂ has a similar structure (monoclinic, space group: P2₁/n), which can be taken as a distorted rutile structure due to the strong Jahn-Teller distortion induced by the Cu²⁺ ([Ar]3d⁹) ion. The distorted structure of CuF₂ becomes more symmetric with Fe incorporation to form the Cu_{y}Fe_{1-y}F₂ solid solution.

The as-synthesized particles may be complex agglomerates of small nanocrystallites (<10 nm), (FIG. 1c). The diffusive ring pattern of electron diffraction (inset of FIG. 1c), despite its broadening arising from nanocrystalline nature of the particles, can be assigned to the tetragonal rutile phase (FIG. 1e). FIG. 1e shows the electron diffraction patterns of ball-milled Cu_{0.5}Fe_{0.5}F₂ (left), FeF₂ (right, upper), and CuF₂ (right, lower). A ring pattern of each sample indicates the formation of nanoparticles. The diffraction pattern of Cu_{0.5}Fe_{0.5}F₂ resembles that of rutile FeF₂ with no additional diffraction, which is identical to the XRD of FIG. 1a. Monoclinic CuF₂ has a more complicated ring pattern due to less symmetric, monoclinic structure to tetragonal FeF₂.

The cathode active materials may exhibit two-step lithiation behavior. For example, the reaction voltages of Cu_{y}Fe_{1-y}F₂ are not identical to CuF₂, FeF₂, or mixture of CuF₂ and FeF₂, indicating the cooperative conversion of Cu and Fe that sit on the same lattice. Similar observations may also be seen in other solid-solution systems. In addition, compared to for example pure FeF₂ the reaction kinetics in the 2^{nd} stage (conversion of intermediate FeF₂) may be improved, which may be indicated by elevated working potentials, and disappearance of the “valley” at the early conversion of FeF₂ (arising from sluggish conversion kinetics).

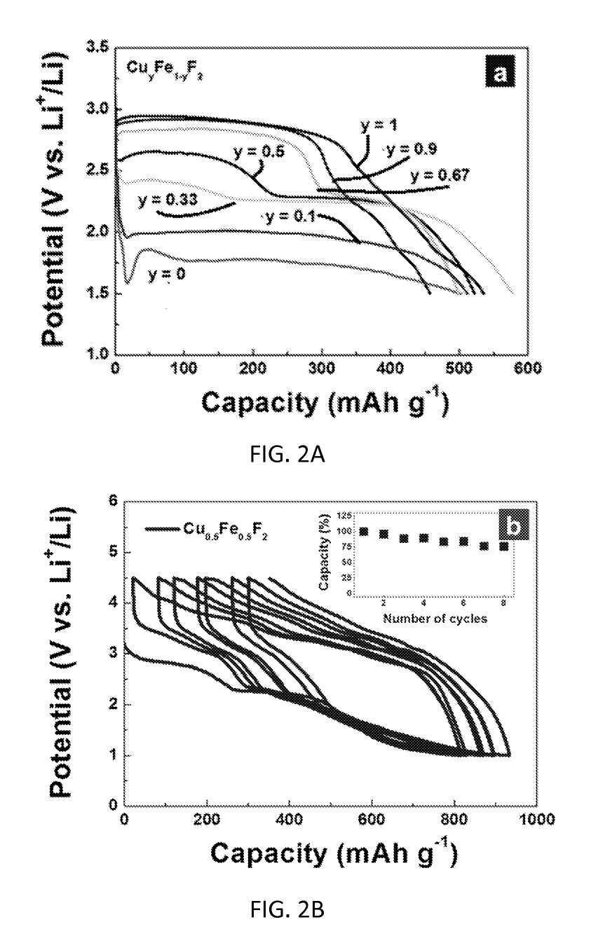

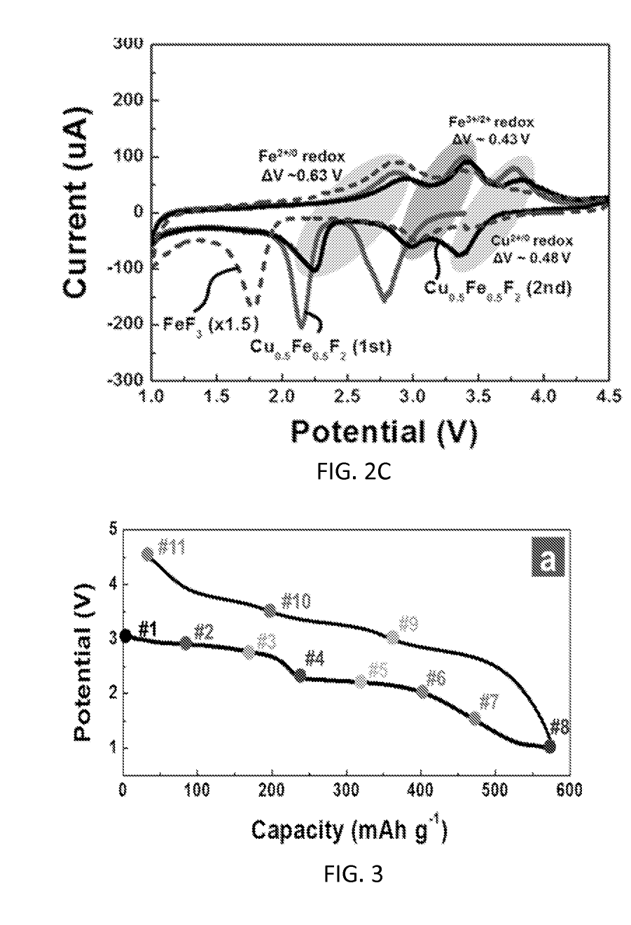

The cathode active materials may exhibit high cycling reversibility. For example, the voltage profile of Cu_{0.5}Fe_{0.5}F₂ for the 1^{st} five cycles is given in FIG. 2a. The similarity of the voltage profiles between different cycles, especially after the 1^{st} discharge (lithiation), indicates the high cycling reversibility. In certain embodiments, the cathode active material has a charge capacity of at least about 80%, 90%, or 93% of the initial discharge capacity. Furthermore, the cathode active material may have a voltage difference between charge and discharge of less than 0.5 V. This reversibility voltage difference may make the cathode active materials suitable for rechargeable lithium-ion batteries.

Additionally, cathode active materials may have a Li/Li′ working potential of at least 2.5 V or 3 V.

Further yet, the cathode active material may have an initial discharge capacity of at least 500, 550, or 575 mAh g⁻¹ with a cut-off voltage of 1.5 V. Embodiments also encompass the cathode active material having a capacity above 350 or 400 mAh g⁻¹ at a current of 100 mA g⁻¹ with a cut-off voltage of 1.5 V.

In one embodiment, the cathode active materials are combined with an electrically conductive material (such as for example carbon black), a binder (such as for example polyvinylidene fluoride), and optionally a solvent (such as N-methyl-2-pyrrolidone). The mixed slurry may then be cast into a film and dried to form a lithium-ion battery cathode.

An embodiment of a lithium ion battery using the lithium ion battery cathode includes: the lithium ion battery cathode, an anode, a separator, a nonaqueous electrolyte solution, an external encapsulating shell, a cathode terminal, and an anode terminal. The lithium-ion battery cathode, the anode, the separator, and the nonaqueous electrolyte solution are encapsulated in the encapsulating shell. The lithium ion battery cathode and the anode may be stacked with each other and may sandwich the separator. The lithium ion battery cathode and the anode can be in contact with or spaced from the separator. The cathode terminal is electrically connected with the cathode. The anode terminal is electrically connected with the anode.

### Examples

### Synthesis of M¹_{y}M²_{1-y}F₂ Solid Solution

For each example, a stoichiometric mixture of two MF₂ compounds selected from CuF₂ (Aldrich, 98%), FeF₂ (Aldrich, 98%), NiF₂ (Aldrich, 98%), and CoF₂ (Aldrich, 98%), was introduced into a stainless steel container inside an Ar-filled glove box. The MF₂ compounds were used as-purchased without any further purification. The container was tightly sealed to prevent air contamination and then transferred to a planetary ball-mill (Fritsch, Pulverisette 6). The mixed powder was ball-milled at 300 RPM for 12 hours for a mechanochemical reaction to form the solid solution phases. After ball-milling, the container was opened inside the Ar-filled glove box to collect the final product.

Characterization of the Solid Solution Materials:

Crystal structure of the samples was determined by XRD at X14A beam line in National Synchrotron Light Source (NSLS) (λ=0.7787 Å). The lattice parameters of the synthesized samples were calculated by Rietveld refinement method using Fullprof software. In-situ high temperature XRD measurement (up to 250° C.) was also carried out to examine the phase stability. Cu_{0.5}Fe_{0.5}F₂ powder was sealed into a quartz tube in the Ar-filled glove box and heated by a heating coil during XRD measurement. XAS measurement was done to determine the chemical nature of Cu K-edge and Fe K-edge at X18A beam line in NSLS. The obtained spectra were analyzed using Athena software. High-resolution (S)TEM images, electron diffraction patterns, EELS mapping were collected from JEOL TEM machine (JEM 2100F) and dedicated STEM (Hitachi, HD2700) equipped with EELS detector (Gatan, Enfina).

Electrochemical Tests:

Cycling performance of Cu_{y}Fe_{1-y}F₂ was measured using the conventional composite electrodes. Active materials (72 wt. %), carbon black (18 wt. %), and polyvinylidene fluoride binder (10 wt. %) were homogeneously mixed together in N-methyl-2-pyrrolidone solvent. The mixed slurry was cast on to Al foil and then dried overnight. All test electrodes were prepared inside the Ar-filled glove box to prevent water absorption. The test electrodes were assembled into CR-2025/2032 type coin cells with Li metal counter electrode, glass fiber separate (Whatman, GF/D), polymer membrane separator (Celgard, 2320), and 1M LiPF₆ electrolyte dissolved in 1:1 (in volume) mixture of ethylene carbonate and dimethylcarbonate (DMC). The test cell was cycled using a battery cycler (Arbin Instrument, BT-2400) in constant current mode to collect the electrochemical data.

Ex-Situ XRD/XAS/TEM/SEM Studies:

Cu_{0.5}Fe_{0.5}F₂ samples at different (dis)charge states were prepared by controlling the cut-off voltage or the cut-off time for the analysis during the electrochemical reaction. The test cells after cycling were disassembled using the coin cell disassembler. The cycled electrodes were rinsed with DMC and then carefully collected inside the Ar-filled glove. For XRD and XAS measurement, the collected electrodes were sealed inside the Kapton tape to minimize air exposure during the measurement. TEM samples were loaded onto TEM holder inside the glove box and then transferred quickly to the TEM machine to minimize the air exposure. The Li metal anode after one cycle was also collected, rinsed with DMC, and then attached on carbon tape for SEM-EDS analysis inside the glove box. The SEM holder was sealed and then transferred to the SEM machine as fast as possible.

DFT Calculation:

All density functional theory (DFT) calculations were performed with the spin-polarized generalized gradient approximation (GGA) within the Perdew-Burke-Ernzerhof (PBE) functional. [J. P. Perdew et al., Phys. Rev. Lett. 77, (1996) 3865] A plane-wave basis set and the projector-augmented wave (PAW) method were used, which implemented in the Vienna ab initio simulation package (VASP). [G. Kresse et al., Comp. Mater. Sci. 6 (1996) 15] The Hubbard parameters (GGA+U) were used to correct the incomplete cancelation of the self-interaction of the GGA. [S. L. Dudarev et al., Phys. Rev. B 57 (1998) 1505] Effective U value of 5.3 eV for Fe ion and 4.0 eV for Cu ion were used. [S. P. Ong et al., Comp. Mater. Sci. 68, 314 (2013) & A. Jain et al., Phys, Rev, B 84, 045114 (2011)] A plane-wave basis set with a kinetic-energy cutoff of 500 eV and 6×4×4 Monkhorst-Pack k-point meshes were used to ensure that the total energies converged to less than 5 meV per formula unit (fu). To investigate the phase stabilities of Cu_{y}Fe_{1-y}F₂ (0≦y≦1), all possible Cu/Fe configurations within triple sized supercells expanded along one of the axes were calculated. 135 configurations within the distorted rutile structure and 78 configurations within the tetragonal rutile structure were considered. All symmetrically distinct configurations were generated with a Cluster-Assisted Statistical Mechanics (CASM) program. [A. Van der Ven et al., J. Math. Comput. Simulat. 80, 1393 (2010)].

Solid solution behavior of ternary metal fluorides: The crystal structures of as-synthesized M¹_{y}M²_{1-y}F₂ powders were examined by synchrotron XRD. FIG. 1a shows the XRD patterns of a CuF₂—FeF₂ system at various Cu/Fe ratios (y in Cu_{y}Fe_{1-y}F₂=0, 0.1, 0.33, 0.5, 0.67, 0.9, 1). Due to ball milling, the synthesized powders lose long-range ordering as indicated by the broadened diffraction peaks. The simple mechanochemical processing of CuF₂—FeF₂ mixture leads to formation of a single-phase solid solution (instead of a mixture of two phases) over the whole compositional range. This may be due to the structural similarity between CuF₂ and FeF₂ (FIG. 1b). The crystal structure of FeF₂ is tetragonal rutile (space group: P4₂/mnm) and is comprised of FeF₆ octahedra. CuF₂ has a similar structure (monoclinic, space group: P2₁/n), which can be taken as a distorted rutile structure due to the strong Jahn-Teller distortion induced by the Cu²⁺ ([Ar]3d⁹) ion. The distorted structure of CuF₂ becomes more symmetric with Fe incorporation to form the Cu_{y}Fe_{1-y}F₂ solid solution. The as-synthesized particles are complex agglomerates of small nanocrystallites (<10 nm), which is typical for ball-milled samples (FIG. 1c). The diffusive ring pattern of electron diffraction (inset of FIG. 1c), despite its broadening arising from nanocrystalline nature of the particles, can be assigned to the tetragonal rutile phase (FIG. 1e). FIG. 1e shows the electron diffraction patterns of ball-milled Cu_{0.5}Fe_{0.5}F₂ (left), FeF₂ (right, upper), and CuF₂ (right, lower). Ring pattern of each sample indicates the formation of nanoparticles. The diffraction pattern of Cu_{0.5}Fe_{0.5}F₂ resembles that of rutile FeF₂ with no additional diffraction, which is identical to the XRD of FIG. 1a. Monoclinic CuF₂ has a more complicated ring pattern due to less symmetric, monoclinic structure to tetragonal FeF₂.

Density functional theory (DFT) calculations were used to predict the stability of all the possible solid solution phases. The energy difference between the possible Cu_{y}Fe_{1-y}F₂ phases and the simple yCuF₂-(1-y)FeF₂ mixture (FIG. 1d) indicates that, regardless of the composition, there exist several Cu_{y}Fe_{1-y}F₂ phases that are energetically more stable (negative energy points) than the simple mixture (zero energy points). The lowest energy points at each composition overlap well with the convex hull (dashed line), indicating that Cu_{y}Fe_{1-y}F₂ can exhibit solid solution behavior over the entire composition range. The structural stability of the solid solution phases was also examined by in situ heating experiment, in which no phase separation was found in Cu_{0.5}Fe_{0.5}F₂ with heating up to 250° C.

Due to incorporation of Cu and Fe into the same lattice, the Cu_{y}Fe_{1-y}F₂ system exhibits two-step lithiation behavior. The reaction voltages of Cu_{y}Fe_{1-y}F₂ are not identical to CuF₂, FeF₂, or mixture of CuF₂ and FeF₂, indicating the cooperative conversion of Cu and Fe that sit on the same lattice. Similar observations were also reported in other solid-solution systems. In addition, compared to pure FeF₂ the reaction kinetics in the 2^{nd} stage (conversion of intermediate FeF₂) was largely improved, which is indicated by elevated working potentials, and disappearance of the “valley” at the early conversion of FeF₂ (arising from sluggish conversion kinetics).

Lattice parameters of Cu_{y}Fe_{1-y}F₂ were evaluated based on the CuF₂-based monoclinic model as shown in FIG. 1g. The β angle gradually increases with Fe content until it reaches 90°, indicating the structural change from the distorted monoclinic to symmetric tetragonal rutile at higher Fe concentrations. Unit cell volume and b/c lattice parameters (corresponding to a/b parameters in the FeF₂-based tetragonal rutile) increase continuously at higher Fe content due to differences in ionic size of Fe²⁺ (92 pm) and Cu²⁺ (87 pm). On the contrary, a lattice parameter (corresponding to c lattice parameter in the tetragonal rutile) decreases up to y=0.5 and then becomes larger gradually, which may be attributed to the change in the β angle, i.e., the inter-axial angle of ac plane.

As most of 3d metal difluorides (i.e. MF₂) have similar structures, either based on the tetragonal rutile or the distorted rutile framework, it is expected that a large variety of solid solutions can be synthesized via mechanochemical reaction. Examples are Cu_{0.5}Ni_{0.5}F₂, Fe_{0.5}Ni_{0.5}F₂, and Ni_{0.5}Co_{0.5}F₂. In FIG. 1F, the formation of new solid solution is verified by XRD. Cu_{0.5}Ni_{0.5}F₂, Fe_{0.5}Ni_{0.5}F₂, and Ni_{0.5}Co_{0.5}F₂ formed the solid solution phase without any phase segregation, demonstrating the wide applicability of the solid solution fluoride system synthesized by the mechanochemical reaction.

This implies the wide applicability of this method for preparing single-phase solid solution of ternary metal fluorides, with varying metal species and stoichiometry.

Electrochemical Properties of Cu_{y}Fe_{1-y}F₂:

Electrochemical measurements were performed on a series of Cu_{y}Fe_{1-y}F₂ samples to investigate their electrochemical properties in the presence of two redox centers (FIG. 2a). During galvanostatic discharge, Cu_{y}Fe_{1-y}F₂ exhibits a two-step lithiation process as expected, but the voltage profiles are different than those obtained from pure CuF₂, FeF₂, or a mixture of the two. In Cu_{y}Fe_{1-y}F₂, the Cu conversion (higher plateau) occurs at similar potentials as CuF₂, while the Fe conversion (lower plateau) occurs at a much higher potential and does not exhibit the voltage dip typically observed in pure FeF₂, indicating a more facile Fe conversion. Even at low Cu concentration (e.g., 10%), significantly higher rate capabilities were achieved in Cu_{0.1}Fe_{0.9}F₂ at room temperature. Similar to other solid-solution systems, the electrochemical properties in the ternary system, Cu_{y}Fe_{1-y}F₂, are significantly affected by the cooperative redox of Cu and Fe sitting on the same lattice. The electrochemical cycling performance of Cu_{0.5}Fe_{0.5}F₂ was measured in the voltage range of 1.0-4.5 V (FIG. 2b). The initial discharge capacity is approximately 575 mAh g⁻¹, comparable with the theoretical value (549 mAh g⁻¹ for 2 electron transfer), and the charge capacity is ˜93% of this value for the initial discharge, indicating the re-oxidization of both the iron and the copper. The reaction process during the subsequent charge and discharge appear to be different than that during the first discharge, as evidenced by the change from two obvious plateaus (˜2.9 and ˜2.2 V) to three plateaus (3.4, 3.0, 2.3 V). Upon subsequent cycles the voltage profiles are similar from cycle to cycle, indicating a high cycling reversibility.

In FIG. 2c, CV curves of Cu_{0.5}Fe_{0.5}F₂ were compared to that of FeF₃ (Lᵢᵤ, P., Vₐjo, J. J., Wang, J. S., Li, W. & Liu, J. Thermodynamics and kinetics of the Li/FeF₃ reaction by electrochemical analysis. J. phys. Chem. C. 116, 6467-6473 (2012)) in order to identify the origin of the cathodic peaks. Accordingly, one cathodic peak can be attributed to Fe^{0/2+} oxidation (at ˜2.8 V), another may to ^{be d}ue to the Fe^{2+/3+} oxidation (˜3.4 V). The third at high^{er vo}ltage (˜3.8 V; being absent from the CV of FeF₃) appears to be related to Cu^{0/2+} oxidatioₙ, and was confirmed by XAS me^{asur}ements (FIG. 3). The initial discharge capacity is approximately 575 mAh g⁻¹, being close to theoretical capacity (54⁸.7 mAh g⁻¹ for 2 Li transfer). The charge capacity ^{is} high, of about 93% to the initial discharge capacity, which indicates the re-oxidization of the converted Cu⁰ upon delithiation; otherwise 50% capacity loss should be expected during reconversion. In contrast to pure CuF₂, which showed no reversible redox Cu peaks, the redox peaks in Cu_{0.5}Fe_{0.5}F₂ are present over multiple cycles, indicating different electrochemical behavior in the solid solution ternary phase.

Besides the high reversibility (shown in FIG. 2b), the voltage hysteresis of Cu_{0.5}Fe_{0.5}F₂ are quite small, of about 0.63 V for Fe^{0/2+} redox, 0.43 V for Fe^{2+/3+}, and 0.48 V for Cu^{0/2+} at a moderate rate (C/40). The values are much less than that of pure FeF₂. This suggests that poor energy efficiency, one of the main issues in using conventional metal fluoride as cathodes, may also be alleviated by forming the solid solution. Furthermore, the voltage hysteresis measured by galvanostatic intermittent titration technique (GITT) is reduced to 148 mV for the Cu^{0/2+} redox and ˜200 mV for the Fe redox, which is substantially lower than recent measurements for pure FeF₂ (700 mV) and comparable to intercalation-type electrodes. This is the lowest reported hysteresis for conversion reaction in any metal fluoride, indicating the potential for achieving high-energy efficiency in ternary fluoride cathodes. In addition, these results also suggest that the hysteresis is not solely determined by the anions, but is also affected by the type of cations present.

Redox Reactions in Cu_{y}Fe_{1-y}F₂ During the 1^{st} Cycle:

XAS measurements on Cu_{0.5}Fe_{0.5}F₂ in the as-synthesized state and at different (de)lithiation states were performed to identify changes in valence and the coordination of Fe and Cu during the 1^{st} cycle (FIG. 3). Upon discharge, the near-edge structure in the XAS (XANES) indicates the Cu conversion occurs first (#1→#4), followed by the Fe conversion (#4→#8) at lower voltages. XANES spectra in Cu K- and Fe K-edges reveal an isobestic point, indicating the two-phase behavior of the conversion reactions. Simultaneous dissociation of Cu—F/Fe—F bond and formation of metallic Cu—Cu/Fe—Fe bonds at each plateau was also confirmed by extended X-ray absorption fine structure (EXAFS). XRD measurements also indicated decomposition of the pristine solid solution phase and formation of metallic Cu⁰ after the high voltage plateau, while there is no visible diffraction peak of FeF₂, indicating the highly disordered nature of the formed FeF₂ after Cu conversion. The intermediate FeF₂ is then reduced to metallic Fe⁰ at lower voltages, according to XRD, XANES, and EXAFS measurements.

At the initial stage of charge (#8→#9), the oxidation state of Fe was increased from 0 to +2 while there is no noticeable difference observed in the valence state of Cu. Upon further delithiation (#9→#11), the oxidation state of Fe continues to increase (indicated by edge shift to higher energies), along with the formation of 2^{nd} isobestic point suggests the over-oxidation of Fe to Fe^{2+/3+}. This is consistent with the similarity in the CV of FeF₃ (FIG. 2c). Considering that there is excess LiF (coming from the Cu conversion during discharge) that can be consumed by Fe reconversion, it is possible that some of the reconverted FeF₂ is further oxidized to form FeF_{2+δ} phase (with Fe valence between +2 and +3). A strong Fe—F peak in the final product, with similar bond distance as that of FeF6 octahedra in rutile phase, suggests the reconversion into a rutile-like framework.

In the high voltage region (above ˜3.4 V), the shift of Cu K-edge to higher energies is a direct experimental evidence proving the reconversion of Cu back to CuF₂-like phase (#10→#11). This is surprising as CuF₂ has been considered suitable only for primary batteries for some time. Reconstruction of the Cu—F bonds was also identified by EXAFS analysis. This may be the first experimental demonstration of the reversibility of the Cu conversion reaction in the fluoride system. The valence state of Cu was not fully recovered to the pristine state (+2) because of the deficiency of the LiF after the over-oxidation of Fe into FeF_{2+δ} phase. A weighted XANES fitting indicates that the reconverted final phase is close to a 1:1 mixture of the metallic Cu⁰ and CuF₂. Despite the reversible redox reaction, no crystalline MFₓ phase was observed in XRD after charge, indicating the formation of disordered fluoride framework. Furthermore, the local coordinate of Cu in the final product appears to be different from that in CuF₂.

Thermodynamics and Kinetics of Conversion Reaction:

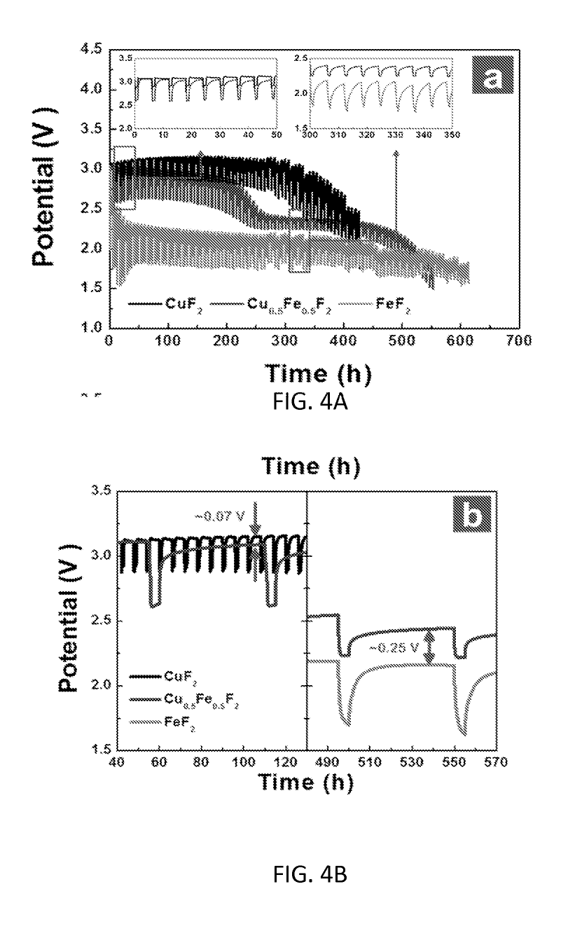

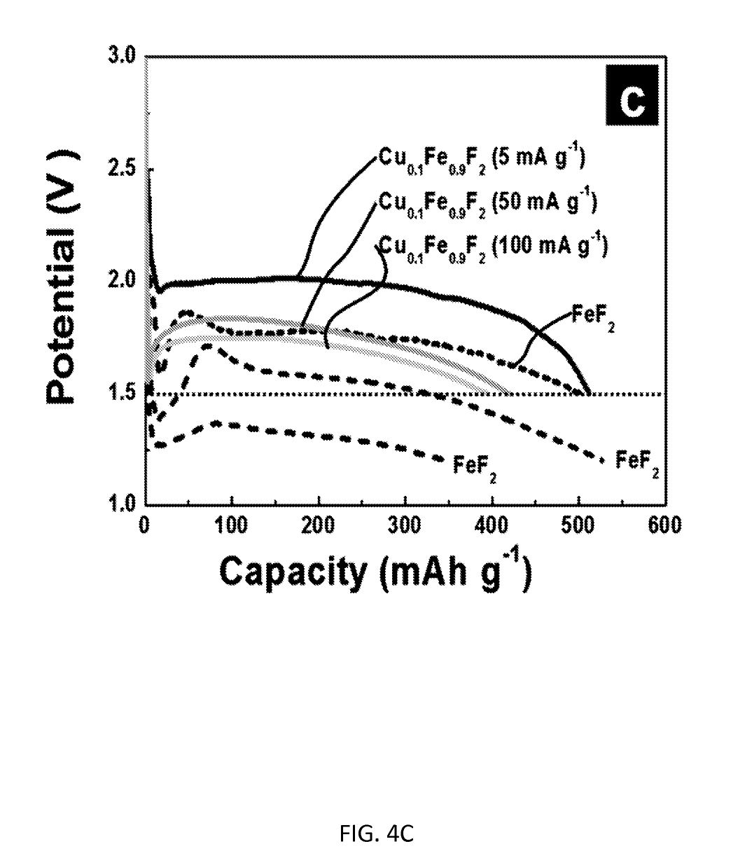

In the galvanostatic experiments (as in FIG. 2), the measured voltage is not solely determined by the intrinsic chemical potential (or thermodynamics), but strongly influenced by kinetics. To separate the intrinsic and kinetic factors, galvanostatic intermittent titration technique (GITT) measurements were performed on Cu_{0.5}Fe_{0.5}F₂ during lithiation. Results are given in FIGS. 4a-4c with comparison to CuF₂ and FeF₂. The voltage difference before and after the relaxation denotes the degree of polarization applied upon the lithiation. FIG. 4a shows the GITT profiles for CuF₂, Cu_{0.5}Fe_{0.5}F₂, and FeF₂ run under the same condition (current applied for 1 h with a 5 h rest). The quasi-equilibrium state was reached quickly in Cu conversion in CuF₂ (i.e., small polarization) but not in Fe conversion in FeF₂ or Cu_{0.5}Fe_{0.5}F₂ within the same relaxation time. This may be explained by the high diffusivity of Cu atoms. The slightly higher polarization of Cu conversion in Cu_{0.5}Fe_{0.5}F₂ may be due to the presence of neighboring Fe, i.e. hindering diffusion of Cu. It is also found that, in spite of the non-saturated voltage, the polarization of Fe conversion is reduced in Cu_{0.5}Fe_{0.5}F₂ (by ˜0.21 V) compared to FeF₂, demonstrating the improved Fe conversion kinetics in the solid solution.

GITT performed with a longer relaxation time (current applied for 5 h with a 50 h rest) was carried out on Cu_{0.5}Fe_{0.5}F₂ and pure FeF₂ to get the quasi-equilibrium state (FIG. 4b). The quasi-equilibrium voltage of each reaction is not identical in the pure and the solid solution systems. The quasi-equilibrium voltage of Fe conversion in Cu_{0.5}Fe_{0.5}F₂ is higher by ˜0.25 V than that in FeF₂, while there is small difference in Cu conversion (˜0.07 V). This indicates that the two cations in the same lattice also influence each other on the intrinsic thermodynamic behavior (in addition to the kinetics). This may be explained by local phase reorganization that was identified by STEM-EELS measurements. The improved conversion kinetics in Fe is due to the formation of nanosized FeF₂ intermediate surrounded by metallic Cu⁰ after Cu conversion at a higher voltage. Such nanostructure is believed to accelerate the Fe conversion reaction because of increased ionic conductivity via the massive LiF/FeF₂ interface and the enhanced electronic transport attributed to metallic Cu⁰. The structural disordering, defect formation, and/or size reduction of the FeF₂ product, as a result of the Cu conversion, may affect the increment of the quasi-equilibrium voltage of Fe conversion in the solid solution since they are strongly correlated with the free energy of materials. Similar observations, namely, elevated conversion potential were also reported in amorphous RuO₂ (compared to crystalline phase). The change in the equilibrium voltage and the kinetics both contributed to the observed low hysteresis of Cu_{0.5}Fe_{0.5}F₂ (FIG. 2b).

The GITT results show the advantage of using a solid solution for batteries, in particular on the lower-voltage-operating cation species (i.e., Fe in Cu_{y}Fe_{1-y}F₂), in terms of reaction kinetics and voltage, and hence, the power capability. In this respect, it appears that minimizing the Cu content in Cu_{y}Fe_{1-y}F₂, (i.e., doping of Cu in FeF₂), may be a viable strategy to improve the electrochemical performance of FeF₂-based cathodes. This hypothesis was verified by much improved electrochemical performance of Cu_{0.1}Fe_{0.9}F₂ than FeF₂, especially at higher currents, as shown in FIG. 4c. The specific capacity and energy density of Cu_{0.1}Fe_{0.9}F₂ at 100 mA g⁻¹ was approximately 400 mAh g⁻¹ and 665 Wh kg⁻¹ above 1.5 V while pure FeF₂ was not active at all in this voltage range. The superior performance of Cu_{0.1}Fe_{0.9}F₂, measured at room temperature without optimization (i.e. via making nanocomposites), is largely due to the in-situ formation of nanosized FeF₂ surrounded with highly conductive Cu⁰. Because the doping can be easily applied to various compounds, this study indicates that doping of a second cation with a higher redox voltage is a promising strategy to improve the rate capability of conversion compounds.

Reaction Pathway in Cu_{0.5}Fe_{0.5}F₂:

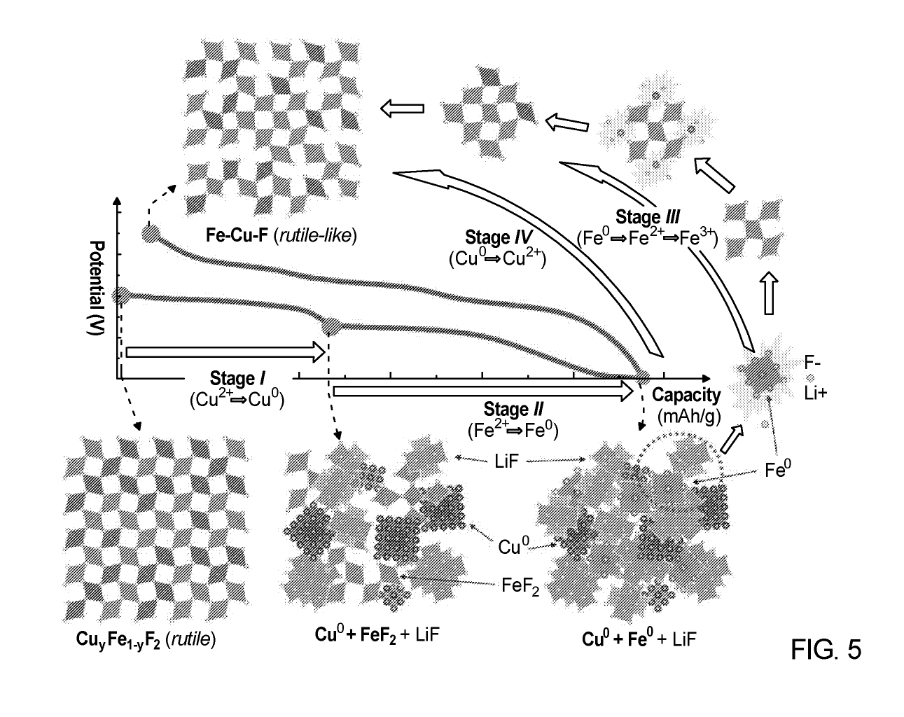

FIG. 5 provides a summary of the reaction pathway and phase evolution in Cu_{y}Fe_{1-y}F₂, based on detailed analysis of structural evolution. The electrochemical reaction and phase evolution during conversion process (Stages I & II) may be well understood, while the reaction during reconversion (Stages III, IV) is may be more complicated, and may follow a different pathway, as illustrated in FIG. 5. The reactions in Stage III, namely Fe reconversion into FeF₂ and subsequently to rutile-like FeF_{2+δ}, may be similar to the observations in previous work. However, in this pathway, the reconversion of Cu back to fluoride phase in the Stage IV is revealed. In contrast to irreversible Cu redox in CuF₂, the reconversion reaction of Cu is likely due to the reduced activation energy for the nucleation and growth of Cu-based fluoride phase at the surface of the pre-formed rutile-like FeF_{2+δ}. As illustrated in FIG. 5, due to the structural similarities, the nucleation of the Cu-based fluoride phase at the FeF_{2+δ} surface should need less energy than that at the free space (i.e. direct nucleation of CuF₂), which could subsequently reduce the overpotential and thus enable the reconversion reaction between Cu and LiF in the reasonable voltage window (<4.5 V). The achievement of the reversible Cu redox also allows for the measurement of the voltage difference of conversion and reconversion process, which is low, of only 0.48 V, according to CV measurements (FIG. 2b). It is believed this is the lowest voltage difference for conversion reactions in fluorides. This indicates the high energy efficiency of Cu conversion reaction besides the high reversibility, both being desired for use in batteries.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. patents, and U.S. Patent Application Publications cited throughout this specification are incorporated by reference as if fully set forth in this specification.

1. A cathode active material for a lithium ion secondary battery, comprising particles of at least one ternary metal compound, wherein the ternary metal has a formula
M¹_{y}M²_{1-y}Aₓ
wherein M¹ and M² are different and are selected from the group consisting of Co, Cu, Fe, Mn, and Ni, A is selected from the group consisting of Cl, F, N, O, and S, y is any number between about 0.05 and about 0.95, and x is any number between about 0.5 and about 4.

2. The cathode active material of claim 1, wherein A is F.

3. The cathode active material of claim 1, wherein y is between about 0.3 and about 0.7, and x is between about 1 and about 3.

4. (canceled)

5. The cathode active material of claim 1, wherein M¹ is Cu.

6. The cathode active material of claim 5, wherein M² is Fe, Ni, or Co.

7-8. (canceled)

9. The cathode active material of claim 1, wherein M¹ is Ni and M² is Co.

10. The cathode active material of claim 1, wherein M¹ is Fe and M² is Ni.

11. The cathode active material of claim 1, wherein the cathode active material has an initial discharge capacity of at least 500 mAh g⁻¹ with a cut-off voltage of 1.5 V.

12. (canceled)

13. The cathode active material of claim 1, wherein the cathode active material has a charge capacity at least about 80% of an initial discharge capacity.

14. (canceled)

15. The cathode active material of claim 1, wherein the cathode active material has a Li/Li⁺ working potential of at least 2.5 V.

16. The cathode active material of claim 1, wherein the cathode active material has a voltage difference between charge and discharge of less than 0.5 V.

17. The cathode active material of claim 1, wherein the particles of at the least one ternary metal compound comprises a single phase.

18. The cathode active material of claim 17, wherein the single phase comprises a solid solution.

19. The cathode active material of claim 18, wherein M¹ and M² occupy a same lattice.

20. The cathode active material of claim 17, wherein the particles display a rutile like structure or a monoclinic like structure.

21. (canceled)

22. A cathode for a lithium-ion secondary battery, comprising the cathode active material for a lithium ion secondary battery of claim 1, an electrically conductive material, and a binder.

23. A lithium-ion secondary battery comprising the cathode of claim 22, an anode, and an electrolyte.

24. A method of forming a cathode active material, the method comprising:
forming a mixture of M¹F₂ compound and a M²F₂ compound, wherein M¹ and M² are different and are selected from the group consisting of Co, Cu, Fe, Mn, and Ni; and
subjecting the mixture to a mechanochemical reaction sufficient to form a solid solution phase.

25. The method of claim 24, wherein the mechanochemical reaction comprises ball-milling the mixture at between about 50 rpm and about 1000 rpm for between about 1 hour and about 25 hours.

26. The method of claim 24, wherein the solid solution phase is a single phase.
